(19) United States
(12) Patent Application Publication
(10) Pub. No.: US 2026/0185581 A1
(43) Pub. Date: Jul. 2, 2026

(54) METHOD OF LOW-FREQUENCY VIBRATION ISOLATION COMPONENT WITH MULTICELL INTERLACING TRIPLY PERIODIC MINIMAL SURFACE LATTICE METAMATERIALS AND VIBRATION ISOLATOR

(71) Applicant: Wuhan University of Technology, Hubei (CN)

(72) Inventors: Lei Yang, Hubei (CN); Mengying Chen, Hubei (CN); Hao Zhou, Hubei (CN); Wenbo Wang, Hubei (CN); Chunze Yan, Hubei (CN); Cong Zhang, Hubei (CN); Jiefei Huang, Hubei (CN); Longxiang Li, Hubei (CN)

(73) Assignee: Wuhan University of Technology, Hubei (CN)

(21) Appl. No.: 19/171,323

(22) Filed: Apr. 6, 2025

(30) Foreign Application Priority Data
Dec. 31, 2024 (CN) 202411978927.2

(51) Int. Cl. F16F 7/12

(52) U.S. Cl. CPC F16F 7/121; F16F 2224/0225; F16F 2226/00

(57) ABSTRACT

The disclosure discloses a design method design method of a low-frequency vibration isolation component with a multicell interlacing triply periodic minimal surface lattice metamaterial and a vibration isolator. The design method includes: determining a cell topology type and interlacing-cell number of the required triply periodic minimal surface lattice metamaterial; based on the cell topology type, constructing a corresponding normal triply periodic minimal surface three-dimensional model; based on the interlacing-cell number, replicating the normal triply periodic minimal surface three-dimensional model along a preset direction at a preset spacing with a corresponding interlacing-cell number to obtain a multicell interlacing triply periodic minimal surface three-dimensional model; removing structures that are not performed with interlacing at edges of the three-dimensional model of the multicell interlacing triply periodic minimal surface, and constructing a bottom plate respectively on a pair of side surfaces thereof to obtain a low-frequency vibration isolation component model.

### CROSS-REFERENCE TO RELATED APPLICATION

This application claims the priority benefit of China application serial no. 202411978927.2, filed on Dec. 31, 2024. The entirety of the above-mentioned patent application is hereby incorporated by reference herein and made a part of this specification.

### BACKGROUND

### Technical Field

The disclosure belongs to a technical field of low-frequency vibration reduction, and more specifically, to a design method of a low-frequency vibration isolation component with multicell interlacing triply periodic minimal surface lattice metamaterials and a vibration isolator.

### Description of Related Art

Low-frequency vibration of mechanical noise is a main source of noise in ship navigation or similar scenarios. Achieving low-frequency vibration isolation while taking into account both bearing performance and vibration isolation performance has always been a major challenge in the field of vibration reduction and noise reduction. Use of a vibration isolator is an effective means to achieve the vibration reduction and noise reduction, which may effectively weaken a vibration source and isolate transmission of vibration, thereby achieving good effects of the vibration reduction and noise reduction. However, limited by a principle of the vibration reduction and noise reduction, stiffness and vibration isolation performance of a conventional vibration isolator show a contradictory inverse relationship. Improving low-frequency vibration isolation performance will inevitably come at the expense of the bearing performance.

With rapid development of a metamaterial, a unit structure of the material is designed to obtain extraordinary physical properties that do not exist in nature, providing new ideas for the vibration reduction and noise reduction. At the same time, thanks to rapid development of additive manufacturing technology, it is possible to prepare a high-precision and high-complexity metamaterial vibration isolator. However, a cell configuration of the existing metamaterial isolator is relatively fixed, and the effect of the vibration isolation is good only within a specific frequency range, making it difficult to achieve broadband and low-frequency vibration isolation while meeting requirements of bearing and vibration isolation.

### SUMMARY

In view of defects in the related art, a purpose of the disclosure is to provide a design method of a low-frequency vibration isolation component with a multicell interlacing triply periodic minimal surface (TPMS) lattice metamaterial and a vibration isolator, aiming to solve an issue that a cell configuration of an existing metamaterial vibration isolator only has an effect of vibration isolation within a specific frequency range, and it is difficult to achieve broadband and low-frequency vibration isolation while meeting multiple requirements of bearing and vibration isolation.

To achieve the above objectives, the disclosure provides a design method of a low-frequency vibration isolation component with a multicell interlacing triply periodic minimal surface lattice metamaterial, including:
in step S1, determining a cell topology type and interlacing-cell number of the required multicell interlacing triply periodic minimal surface lattice metamaterial, in which the cell topology type comprises a Gyroid triply periodic minimal surface structure, an IWP triply periodic minimal surface structure, and a Diamond triply periodic minimal surface structure;
in step S2, constructing a corresponding normal triply periodic minimal surface three-dimensional model based on the cell topology type, and based on the interlacing-cell number, replicating the normal triply periodic minimal surface three-dimensional model with a corresponding interlacing-cell number along a preset direction at a preset spacing to obtain a multicell interlacing triply periodic minimal surface three-dimensional model, wherein the preset spacing is less than a side length of a corresponding cell structure;
in step S3, removing structures that are not interlacing at edges of the multicell interlacing triply periodic minimal surface three-dimensional model;
in step S4, constructing a bottom plate with a preset thickness on a pair of side surfaces of the multicell interlacing triply periodic minimal surface three-dimensional model with redundant structures removed to obtain a low-frequency vibration isolation component model.

Furthermore, in step S2, a side length of the normal triply periodic minimal surface three-dimensional model is equal to a side length of the multicell interlacing triply periodic minimal surface three-dimensional model after removing the redundant structures.

Furthermore, when the cell topology type is determined to be a Gyroid surface, the corresponding interlacing-cell number is double interlacing, quadruple interlacing, or octuple interlacing. In step S2, a normal Gyroid triply periodic minimal surface model is first constructed, and then based on the corresponding interlacing-cell number, the normal Gyroid triply periodic minimal surface model is replicated with the corresponding interlacing-cell number along the preset direction at the preset spacing to obtain a multicell interlacing Gyroid triply periodic minimal surface model.

Furthermore, in step S2, steps of performing multicell interlacing replication on the normal Gyroid triply periodic minimal surface model along the preset direction at the preset spacing multiple times to obtain the multicell interlacing triply periodic minimal surface three-dimensional model are:
replicating the normal Gyroid triply periodic minimal surface model at the spacing of

$$\frac{a}{2}$$

in an X axis direction to obtain a double interlacing Gyroid triply periodic minimal surface model, wherein a is a side length of a cell structure in the normal Gyroid triply periodic minimal surface model;
replicating the double interlacing Gyroid triply periodic minimal surface model at the spacing of

$$\frac{a}{2}$$

in a Y-axis direction to obtain a quadruple interlacing Gyroid triply periodic minimal surface model;
replicating the quadruple interlacing Gyroid triply periodic minimal surface model at

$$\frac{a}{4}$$

in the X-axis direction, the Y-axis direction, and a Z-axis direction respectively to an octuple interlacing Gyroid triply periodic minimal surface model.

Furthermore, in step S1, when the cell topology type is determined to be an IWP surface, the corresponding interlacing-cell umber is double interlacing or quadruple interlacing. In step S2, a normal IWP triply periodic minimal surface model is constructed, and based on the corresponding interlacing-cell number, multicell interlacing replication is performed on the normal IWP triply periodic minimal surface model along the preset direction and at the preset spacing to obtain a multicell interlacing IWP triply periodic minimal surface model.

Furthermore, based on the corresponding interlacing-cell number, steps of performing the multicell interlacing replication on the normal IWP triply periodic minimal surface model along the preset direction at the preset spacing are:
replicating the normal IWP triply periodic minimal surface model at a spacing of

$$\frac{b}{2}$$

along an X-axis direction, and then replicating at

$$\frac{b}{4}$$

along a Y-axis direction to obtain a double interlacing IWP triply periodic minimal surface model;
replicating the double interlacing IWP triply periodic minimal surface model at a spacing of

$$\frac{b}{8}$$

along the X-axis direction, and then replicating at the spacing of

$$\frac{b}{2}$$

along the Y-axis direction to obtain a quadruple interlacing IWP triply periodic minimal surface model.

Furthermore, in step S1, when the cell topology type is determined to be a Diamond surface, the corresponding interlacing-cell number is double interlacing or quadruple interlacing. In step S2, a normal Diamond triply periodic minimal surface model is constructed, and based on the corresponding interlacing-cell number, multicell interlacing replication is performed on the normal Diamond triply periodic minimal surface model along the preset direction at the preset spacing to obtain a multicell interlacing Diamond triply periodic minimal surface model.

Furthermore, that based on the corresponding interlacing-cell number, steps of performing the multicell interlacing replication on the normal Diamond triply periodic minimal surface model along the preset direction at the preset spacing are:
replicating the normal Diamond triply periodic minimal surface model at the spacing of

$$\frac{c}{4}$$

along an X-axis direction, and then replicating at

$$\frac{c}{8}$$

along a Y-axis direction to obtain a double interlacing Diamond triply periodic minimal surface model;
replicating the double interlacing Diamond triply periodic minimal surface model at the spacing of

$$\frac{c}{8}$$

along the X-axis direction, and then replicating at the spacing of

$$\frac{c}{4}$$

along the Y-axis direction to obtain a quadruple interlacing Diamond triply periodic minimal surface model.

According to another aspect of the disclosure, a vibration isolator is further provided. The vibration isolator includes a connection cover, a base, and a vibration isolation component. A model of the vibration isolation component is obtained by any of the above design methods. The vibration isolator includes a connection cover, a base, and a vibration isolation component. A vibration isolation cavity with an opening is disposed in the base. The vibration isolation component is disposed in the vibration isolation cavity. The connection cover is cooperatively connected to the base to close the opening of the vibration isolation cavity to limit the vibration isolation component in the vibration isolation cavity.

Furthermore, an implant frame is disposed at a bottom of the vibration isolation cavity. A square countersunk hole is disposed on a bottom surface of the vibration isolation component. The implant frame is embedded in the square countersunk hole. The adjusting gasket is disposed between the vibration isolation component and a side wall of the vibration isolation cavity. Multiple pairs of adjusting screws are disposed on a side wall of the base. One end of the adjusting screw is located in the vibration isolation cavity and abuts against the adjusting gasket to limit the vibration isolation component.

In general, the above technical solutions conceived in the disclosure have the following beneficial effects compared with the related art.
(1) In the design method provided in the disclosure, a variety of triply periodic minimal surface cells are constructed, including a Gyroid triply periodic minimal surface cell structure, an IWP triply periodic minimal surface cell structure, and a Diamond triply periodic minimal surface unit cell structure, and the three triply periodic minimal surface cell structures are used to interlace and reconstruct the required three-dimensional model of the multicell interlacing triply periodic minimal surface lattice structure material. Then, different types of multicell interlacing triply periodic minimal surface lattice material structures are used to design a solid model of the vibration isolation component. Compared with the vibration isolation component of the existing vibration isolator, the multicell interlacing Gyroid triply periodic minimal surface lattice structure, the multicell interlacing IWP triply periodic minimal surface lattice structure, and the multicell interlacing Diamond triply periodic minimal surface lattice structure obtained by the above design method have uniform surface transitions, no sharp inflection points, uniform stress distribution, and high fatigue life.
(2) In the design method provided in the disclosure, the required vibration isolation component may be customized according to application scenarios. Since a structural form and multicell interlacing number of the triply periodic minimal surface lattice structure are controlled and designed by a corresponding implicit function formula, triply periodic minimal surface lattice structures with different structural forms and different interlacing-cell may be generated by performing multiple decomposition and interlacing on different triply periodic minimal surface unit cell structures. Therefore, it has a large degree of design freedom. As long as design parameters are changed according to requirements during a design process, multicell interlacing triply periodic minimal surface lattice structures with different volume fractions and different cell sizes may be generated, which may be more adaptable to more actual vibration reduction scenarios.
(3) In the design method provided in the disclosure, by performing multicell interlacing on the normal triply periodic minimal surface structure to form a multicell interlacing triply periodic minimal surface lattice structure, stiffness superposition and a damping ratio are improved, and contradiction between stiffness and vibration isolation performance is well adjusted, so that the vibration isolation component meets bearing capacity while having a lower vibration isolation frequency and a wider vibration isolation frequency band.

### BRIEF DESCRIPTION OF THE DRAWINGS

FIG. 1 is a schematic view of a flow chart of a design method of a low-frequency vibration isolation component with a multicell interlacing triply periodic minimal surface lattice metamaterial provided in the disclosure.

FIG. 2 is a schematic view of a flow chart of a design, processing, and application of a low-frequency vibration isolation component with a multicell interlacing triply periodic minimal surface lattice metamaterial provided in the disclosure.

FIG. 3 is a schematic view of cell structures corresponding to a Gyroid surface, an IWP surface, and a Diamond surface provided in the disclosure.

FIG. 4 is a schematic view of an evolution process of replication of normal, double interlacing, quadruple interlacing, and octuple interlacing Gyroid triply periodic minimal surface structures provided in the disclosure.

FIG. 5 is a schematic view of an evolution process of replication of normal, double interlacing, and quadruple interlacing IWP triply periodic minimal surface structures provided in the disclosure.

FIG. 6 is a schematic view of an evolution process of replication of normal, double interlacing, and quadruple interlacing Diamond triply periodic minimal surface structures provided in the disclosure.

FIG. 7 is a schematic view of a structure of a vibration isolator having a vibration isolation component with a quadruple interlacing Gyroid triply periodic minimal surface lattice material provided in an embodiment of the disclosure.

FIG. 8 is a schematic cross-sectional view of a structure of a vibration isolator without a vibration isolation component with a quadruple interlacing Gyroid triply periodic minimal surface lattice material provided in an embodiment of the disclosure.

FIG. 9 is a schematic cross-sectional view of a structure of a vibration isolator having a vibration isolation component with a quadruple interlacing Gyroid triply periodic minimal surface lattice material provided in an embodiment of the disclosure.

FIG. 10 is a schematic view of a three-dimensional structure of a vibration isolation component with a quadruple interlacing Gyroid triply periodic minimal surface lattice material from one perspective provided in an embodiment of the disclosure.

FIG. 11 is a schematic view of a three-dimensional structure of a vibration isolation component with a quadruple interlacing Gyroid triply periodic minimal surface lattice material from another perspective provided in an embodiment of the disclosure.

Throughout the drawings, the same reference numerals are used to denote the same elements or structures, where 1—connection cover, 2—base, 21—vibration isolation cavity, 3—lower rubber vibration reduction friction pad, 4—upper rubber vibration reduction friction pad, 5—sealing ring, 6—fastening bolt, 7—implant frame, 8—fixing bolt, 9—adjusting screw, 10—bolt, 11—vibration isolation component, 12—adjusting gasket, 13—screw handle, 14—round countersunk hole, 15—square countersunk hole.

### DETAILED DESCRIPTION OF DISCLOSED EMBODIMENTS

In order for the objectives, technical solutions, and advantages of the disclosure to be more comprehensible, the disclosure is further described in detail below in conjunction with the embodiments accompanied with drawings. It should be understood that the specific embodiments described herein are only used to describe the disclosure and are not used to limit the disclosure.

The term “and/or” herein is a description of an association relationship of associated objects, indicating that there may be three relationships. For example, A and/or B may indicate three situations, which are that A exists alone, A and B exist at the same time, and B exists alone. The symbol “/” herein indicates that the associated objects are in an or relationship. For example, A/B means A or B.

The terms “first”, “second”, etc. in the specification and claims herein are used to distinguish different objects rather than to describe a specific order of the objects. For example, a first response message and a second response message are used to distinguish different response messages rather than to describe a specific order of the response messages.

In the embodiments of the disclosure, words such as “exemplary” or “for example” are used to indicate examples, illustrations, or descriptions. Any embodiment or design described as “exemplary” or “for example” in the embodiments of the disclosure should not be construed as being preferred or advantageous over other embodiments or designs. Specifically, the use of words such as “exemplary” or “for example” are intended to present relevant concepts in a specific manner.

In the description of the embodiments of the disclosure, unless otherwise specified, the meaning of “multiple” refers to two or more than two. For example, multiple processing units refers to two or more processing units, etc., and multiple elements refers to two or more elements, etc.

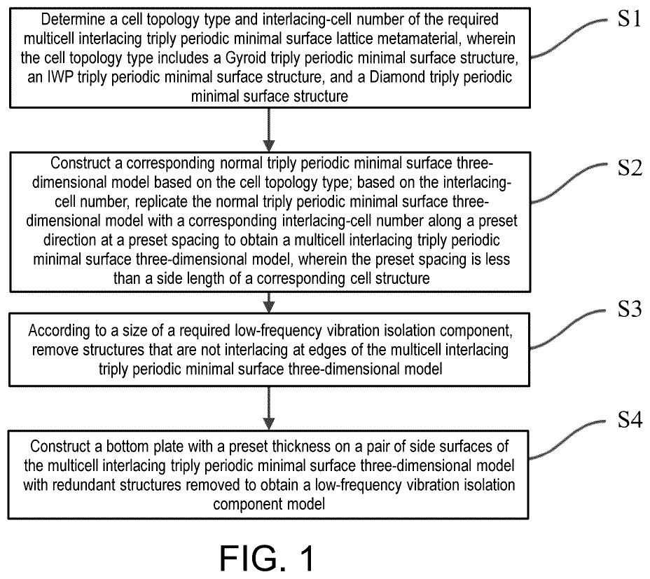

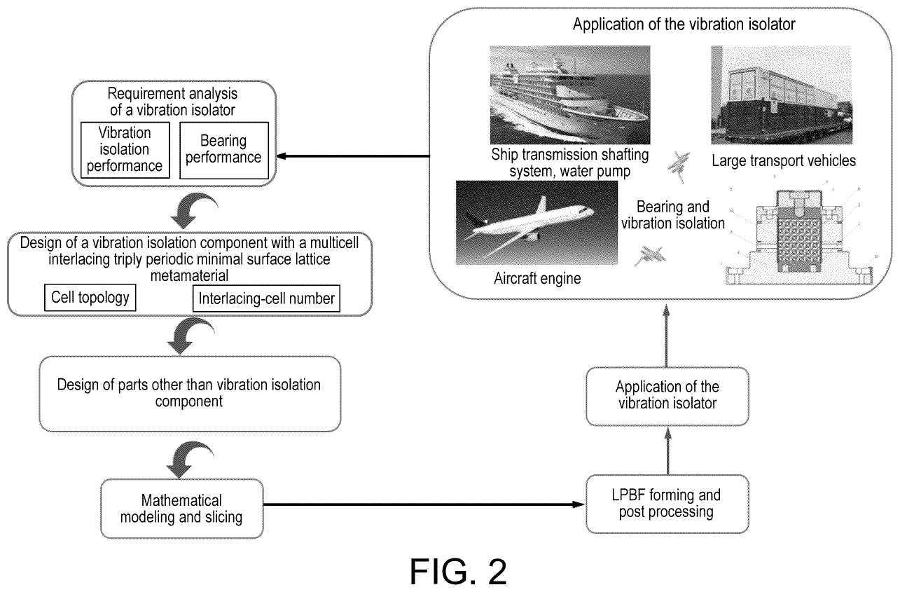

The disclosure provides a design method of a low-frequency vibration isolation component with a multicell interlacing triply periodic minimal surface lattice metamaterial. As shown in FIGS. 1 and 2, the design method includes the following steps.

In S1, a cell topology type and interlacing-cell number of the required multicell interlacing triply periodic minimal surface lattice metamaterial are determined. The cell topology type includes a Gyroid triply periodic minimal surface structure, an IWP triply periodic minimal surface structure, and a Diamond triply periodic minimal surface structure.

In S2, a corresponding normal triply periodic minimal surface three-dimensional model is constructed based on the cell topology type. Based on the interlacing-cell number, the normal triply periodic minimal surface three-dimensional model is replicated with a corresponding interlacing-cell number along a preset direction at a preset spacing to obtain a multicell interlacing triply periodic minimal surface three-dimensional model. The preset spacing is less than a side length of a corresponding cell structure.

In S3, structures that are not interlacing at edges of the multicell interlacing triply periodic minimal surface three-dimensional model are removed.

In S4, a bottom plate with a preset thickness is constructed on a pair of side surfaces of the multicell interlacing triply periodic minimal surface three-dimensional model with redundant structures removed to obtain a low-frequency vibration isolation component model.

In step S1, a demand analysis is first performed based on specific working conditions to determine an effect of vibration isolation, a frequency range, bearing capacity, etc. required by the vibration isolator. The required vibration isolation component and other parts that cooperate with the vibration isolation component are designed to generate a three-dimensional model, so that the solid model may meet the effect of vibration isolation and the bearing capacity required by the vibration isolator under the working conditions.

Specifically, according to working conditions of different applications of the vibration isolator, structural characteristics and related force-vibration performance required by the vibration isolator are analyzed. Then, a Gibson-Ashby model is established, and correlation between a Young's modulus and a volume fraction is obtained.

$$\frac{{E}_{c}}{{E}_{s}} = {{C}_{1} ( \frac{ρ}{{ρ}_{s}} )}^{n} \qquad ( 1 )$$

$$Where \frac{ρ}{{ρ}_{s}} = {ρ}_{RD} ,$$

ρ is a density measured in an actual lattice structure, and ρₛ is a density of a matrix material, where m=b−3j+6. E_{c} is an elastic modulus of a porous structure, Eₛ is an elastic modulus of the matrix material, c and n are all scaling factors, ρ_{RD} is a lattice relative density (volume fraction), b is the number of lattice pillars, and j is the number of lattice nodes. When m<0, the lattice is dominated by bending, and for the elastic modulus of the porous structure, the scaling factor is taken as 1. When m≥0, the lattice is dominated by stretching, and for the elastic modulus, the scaling factor is taken as

$$\frac{1}{3} .$$

Then, based on structural performance of the vibration isolator, the cell topology type and multicell interlacing way of the multicell interlacing triply periodic minimal surface lattice metamaterial required for the vibration isolation component in the vibration isolator are determined. For example, according to the effect of vibration isolation and the bearing capacity, a cell type, a cell size, a cell volume fraction, etc. of the multicell interlacing triply periodic minimal surface lattice metamaterial are determined, and the interlacing-cell number of the lattice structure is determined.

Specifically, in step S1, when the cell topology type is determined to be a Gyroid surface, the corresponding interlacing-cell number may be selected to be double interlacing, quadruple interlacing, and octuple interlacing. When the cell topology type is determined to be an IWP surface, the corresponding interlacing-cell number may be selected to be double interlacing and quadruple interlacing. When the cell topology type is determined to be a diamond surface, the corresponding interlacing-cell number may be selected to be double interlacing and quadruple interlacing.

In step S2, according to the different cell topology types of the triply periodic minimal surface, a corresponding implicit function formula (the following control formula) is used to first form an array structure based on a corresponding cell structure model. The array structure is a normal triply periodic minimal surface three-dimensional model, which may meet the structural characteristics and related force-vibration performance required by the vibration isolation component.

The control formulas of the three normal triply periodic minimal surface three-dimensional models provided in the disclosure are as follows.

The control formula of Gyroid is:

$$sin ( \frac{2 π}{a} \cdot x ) cos ( \frac{2 π}{a} \cdot y ) + sin ( \frac{2 π}{a} \cdot y ) cos ( \frac{2 π}{a} \cdot z ) + sin ( \frac{2 π}{a} \cdot z ) cos ( \frac{2 π}{a} \cdot x ) = t . \qquad ( 2 )$$

The control formula of IWP is:

$$2 * ( cos ( \frac{π}{b} \cdot x ) cos ( \frac{π}{b} \cdot y ) + cos ( \frac{π}{b} \cdot y ) cos ( \frac{π}{b} \cdot z ) + cos ( \frac{π}{b} \cdot z ) cos ( \frac{π}{b} \cdot x ) ) - ( cos ( \frac{2 π}{b} \cdot x ) + cos ( \frac{2 π}{b} \cdot y ) + cos ( \frac{2 π}{b} \cdot z ) ) = t . \qquad ( 3 )$$

The control formula of diamond is:

$$sin ( \frac{2 π}{c} \cdot x ) sin ( \frac{2 π}{c} \cdot y ) sin ( \frac{2 π}{c} \cdot z ) + sin ( \frac{2 π}{c} \cdot y ) cos ( \frac{2 π}{c} \cdot y ) cos ( \frac{2 π}{c} \cdot z ) + cos ( \frac{2 π}{c} \cdot x ) sin ( \frac{2 π}{c} \cdot y ) cos ( \frac{2 π}{c} \cdot z ) + cos ( \frac{2 π}{c} \cdot x ) cos ( \frac{2 π}{c} \cdot y ) sin ( \frac{2 π}{c} \cdot z ) = t . \qquad ( 4 )$$

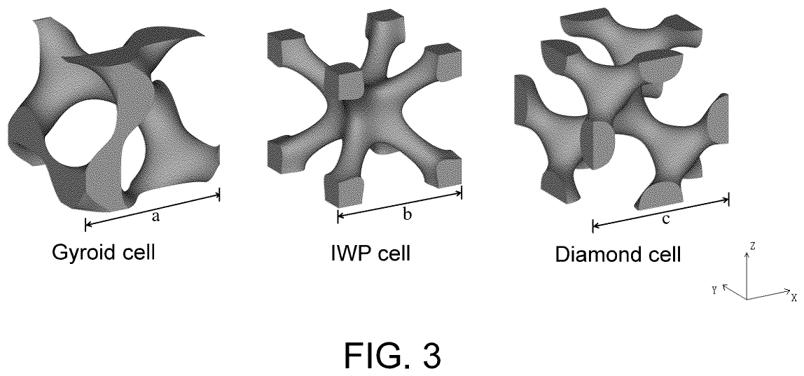

As shown in FIG. 3, a, b, and c are side lengths of the cell structures that constitute different normal triply periodic minimal surface three-dimensional models, t is a cell volume fraction control parameter, x represents a corresponding x-axis coordinate in a coordinate system, y represents a corresponding y-axis coordinate in the coordinate system, and z represents a corresponding z-axis coordinate in the coordinate system. A deformation mechanism of a rod in each of cells determines stiffness and damping performance thereof. The deformation mechanism of the rod in Gyroid, Diamond, and IWP is dominated by bending.

Then, according to the different interlacing-cell number, a modeling software is used to decompose and interlace the above constructed normal triply periodic minimal surface three-dimensional model.

Specifically, in step S2, when the cell topology type is determined to be the Gyroid surface, a normal Gyroid triply periodic minimal surface model is first constructed using multiple Gyroid cells with a side length of a. The normal Gyroid triply periodic minimal surface model is an array structure formed by multiple corresponding cells. As shown in FIG. 3, then, based on the corresponding interlacing-cell number, multicell interlacing replication is performed on the normal Gyroid triply periodic minimal surface model along the preset direction at the preset spacing to obtain a multicell interlacing Gyroid triply periodic minimal surface model.

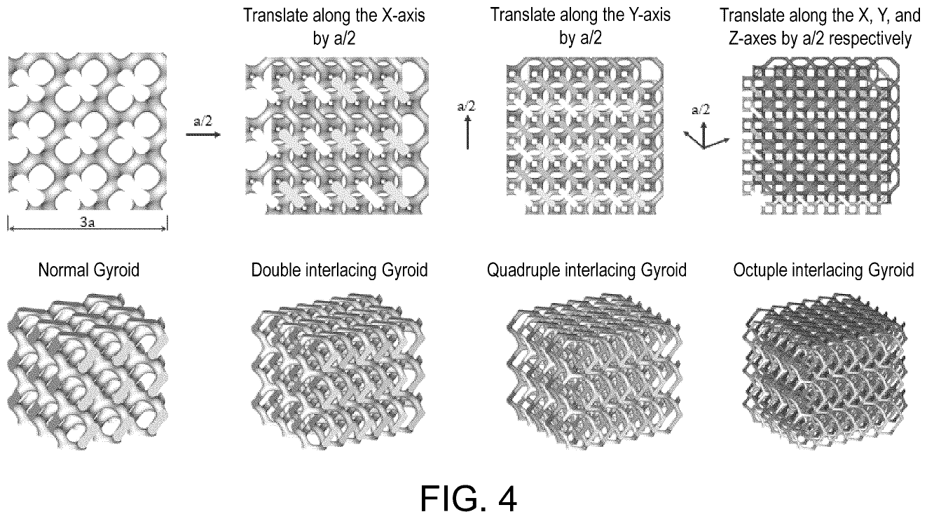

Steps of performing multicell interlacing replication on the normal Gyroid triply periodic minimal surface model along the preset direction at the preset spacing multiple times to obtain the multicell interlacing triply periodic minimal surface three-dimensional models as shown in FIG. 4 are as follows.
(1) The normal Gyroid triply periodic minimal surface model shown in FIG. 4 is replicated at a spacing of

$$\frac{a}{2}$$

in an X-axis direction to obtain a double interlacing Gyroid triply periodic minimal surface model.
(2) In order to obtain a quadruple interlacing Gyroid triply periodic minimal surface model shown in FIG. 4, step (1) is repeated to obtain the double interlacing Gyroid triply periodic minimal surface model. Then, the double interlacing Gyroid triply periodic minimal surface model is replicated at the spacing of

$$\frac{a}{2}$$

in the Y-axis direction to obtain the quadruple interlacing Gyroid triply periodic minimal surface model.
(3) In order to obtain an octuple interlacing Gyroid triply periodic minimal surface model shown in FIG. 4, step (2) is repeated to obtain the quadruple interlacing Gyroid triply periodic minimal surface model. Then, the quadruple interlacing Gyroid triply periodic minimal surface model is replicated at

$$\frac{a}{4}$$

in the X-axis direction, the Y-axis direction, and the Z-axis direction respectively. Similarly, the octuple interlacing Gyroid triply periodic minimal surface model may be obtained.

In step S2, when the cell topology type is determined to be the IWP surface, multiple IWP cells with a side length of b are used to construct a normal IWP triply periodic minimal surface model, and the normal IWP triply periodic minimal surface model is also an array structure formed by corresponding cells. Based on the corresponding interlacing-cell number, multicell interlacing replication is performed on the normal IWP triply periodic minimal surface model along the preset direction at the preset spacing to obtain a multicell interlacing IWP triply periodic minimal surface model.

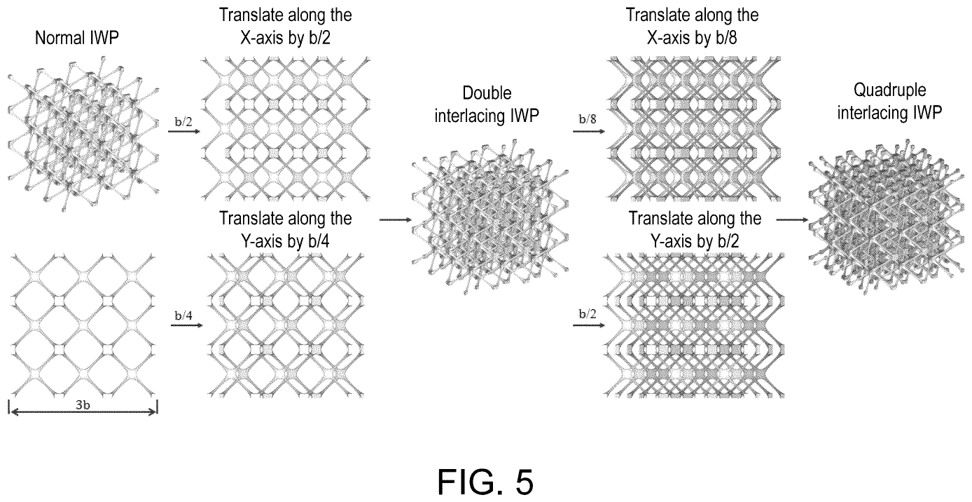

As shown in FIG. 5, based on the corresponding interlacing-cell number, steps for performing multicell interlacing replication on the normal IWP triply periodic minimal surface model along the preset direction at the preset spacing are as follows.
(1) The normal IWP triply periodic minimal surface model is replicated at a spacing

$$\frac{b}{2}$$

along the X-axis direction, and then replicated at

$$\frac{b}{4}$$

along the Y-axis direction, so as to obtain a double interlacing IWP triply periodic minimal surface model.
(2) In order to obtain a quadruple interlacing IWP triply periodic minimal surface model, first step (1) is repeated to obtain the double interlacing IWP triply periodic minimal surface model. Then, the double interlacing IWP triply periodic minimal surface model is replicated at a spacing of

$$\frac{b}{8}$$

along the X-axis direction, and then replicated at the spacing of

$$\frac{b}{2}$$

along the Y-axis direction, so as to obtain the quadruple interlacing IWP triply periodic minimal surface model.

In step S2, when the cell topology type is determined to be the Diamond surface, a normal Diamond triply periodic minimal surface model is first constructed using multiple Diamond cell structures with a side length of c. The normal Diamond triply periodic minimal surface model is an array structure formed by the Diamond cell structures. Based on the corresponding interlacing-cell number, multicell interlacing replication is performed on the normal Diamond triply periodic minimal surface model along the preset direction at the preset spacing to obtain a multicell interlacing Diamond triply periodic minimal surface model.

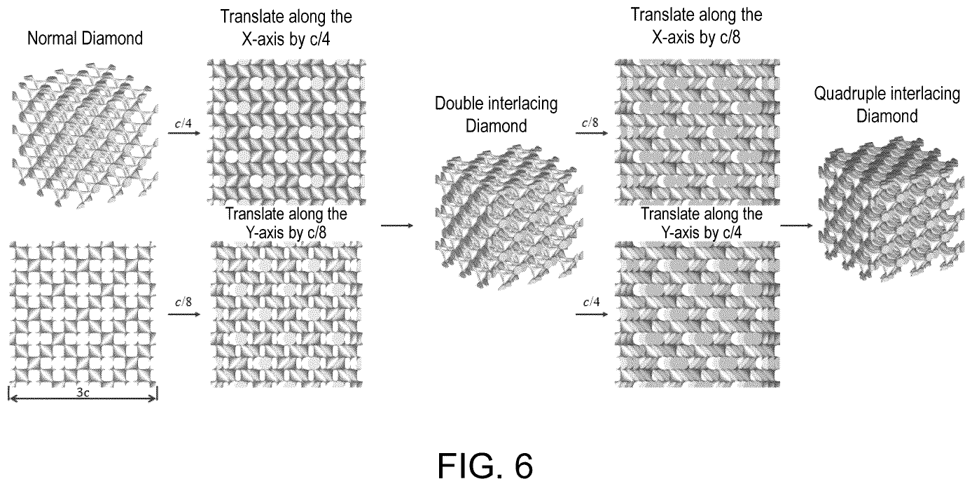

Specifically, as shown in FIG. 6, based on the corresponding interlacing-cell number, steps of performing multicell interlacing replication on the normal Diamond triply periodic minimal surface model along the preset direction at the preset spacing are as follows.
(1) The normal Diamond triply periodic minimal surface model is replicated at a spacing of

$$\frac{c}{4}$$

along the X-axis direction, and then replicated at

$$\frac{c}{8}$$

along the Y-axis direction, so as to obtain a double interlacing Diamond triply periodic minimal surface model.
(2) To obtain a quadruple interlacing Diamond triply periodic minimal surface model, step (1) is repeated to obtain the double interlacing Diamond triply periodic minimal surface model. Then, the double interlacing Diamond triply periodic minimal surface model is replicated at the spacing of

$$\frac{c}{8}$$

along the X-axis direction, and then replicated at the spacing of

$$\frac{c}{4}$$

along the Y-axis direction, so as to obtain the quadruple interlacing Diamond triply periodic minimal surface model.

In summary, generation principles of the above multicell interlacing triply periodic minimal surface lattice metamaterial three-dimensional models are as follows. First, the normal triply periodic minimal surface three-dimensional model is constructed using the cell structure of the corresponding surface, and then the normal triply periodic minimal surface three-dimensional model is subjected to multiple decomposition and multicell interlacing. That is, a normal lattice with a large volume fraction is converted into multiple lattices with a small volume fraction and interlacing with each other, so as to obtain multicell interlacing triply periodic minimal surface lattice metamaterial three-dimensional models with different interlacing-cell numbers. For example, each time when replication is performed along the preset direction at the preset spacing, the volume fraction of the normal triply periodic minimal surface three-dimensional model will be reduced by half, so that the volume fraction of the multicell interlacing triply periodic minimal surface three-dimensional model after replication may be kept at an original design value.

In step S3, the edges of the obtained various multicell interlacing triply periodic minimal surface lattice metamaterial three-dimensional models that are not interlacing are removed. A side length of the multicell interlacing triply periodic minimal surface lattice metamaterial three-dimensional model after removing the redundant normal structures at the edge is equal to a side length of the initial normal triply periodic minimal surface three-dimensional model in step S3.

In step S4, a connecting plate body having a thickness that meets requirements of the vibration isolation component is designed on a pair of side surfaces of the multicell interlacing triply periodic minimal surface lattice metamaterial three-dimensional model with the removed the edge portion, thereby obtaining a required three-dimensional model of a multicell interlacing triply periodic minimal surface vibration isolation component. The three-dimensional model of the vibration isolation component is then exported as an STL file and sliced and imported into a laser powder bed melting device for processing.

A specific additive preparation method is that any one of nickel-titanium alloy materials, such Ni_{50.8}Ti_{49.2}, Ni_{56.8}Ti_{43.2}, Ni_{50.5}Ti_{49.5}, Ni₄₉Ti₄₄Cu₅Fe₂, Ni₅₀Ti₄₂Zr₆, Ni_{39.8}Cu₁₀Ti_{40.2}Hf₁₀, Al₃Ni₂Ti₃, Al₃NiTi₂, Ni₅₀Ti₄₅Ta₅, are selected as an additive preparation material.

Appropriate working parameters are selected, and LPBF forming (laser powder bed melting technology) is performed under protection of inert gas. The working parameters may be selected as follows. Laser power is 125 w. A scanning speed is 600 mm/s. A layer thickness is 30 μm. A scanning spacing is 100 μm. A spot diameter is 50. Forming is performed under protection of the inert gas of argon to prepare the vibration isolation component with a multicell interlacing triply periodic minimal surface lattice metamaterial.

After forming, post processing is performed on the vibration isolation component with the multicell interlacing triply periodic minimal surface lattice metamaterial. An in-situ annealing processing is performed under the protection of inert gas to remove internal thermal stress of a sample. The sample is separated from a substrate using a wire cutting process, and then a sand blasting processing is performed, so as to obtain a metamaterial vibration isolation component with a smooth surface and excellent performance.

According to three-dimensional models of other parts in the initial design, corresponding parts are prepared to support and fix the vibration isolation component to be combined to form the required vibration isolator.

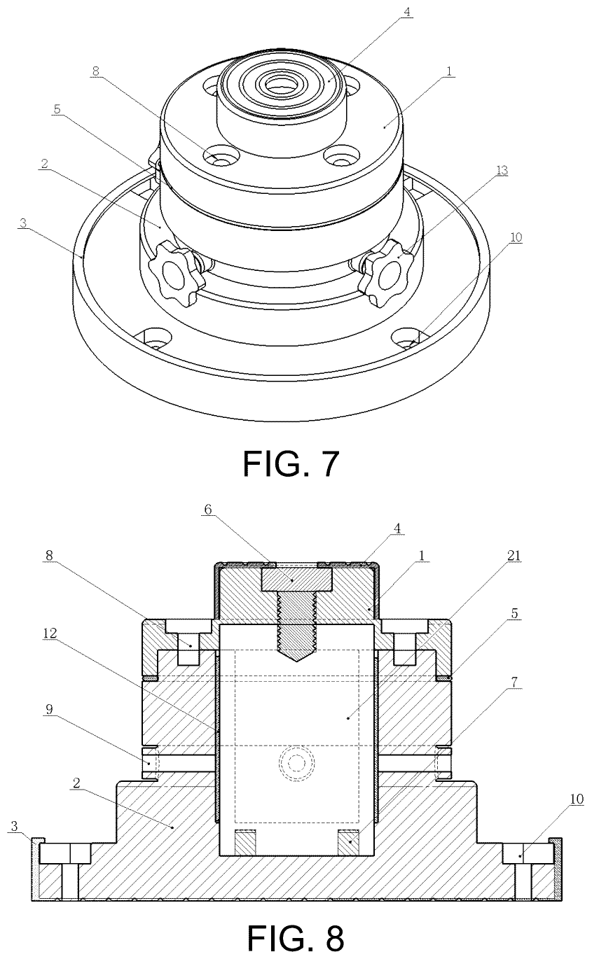

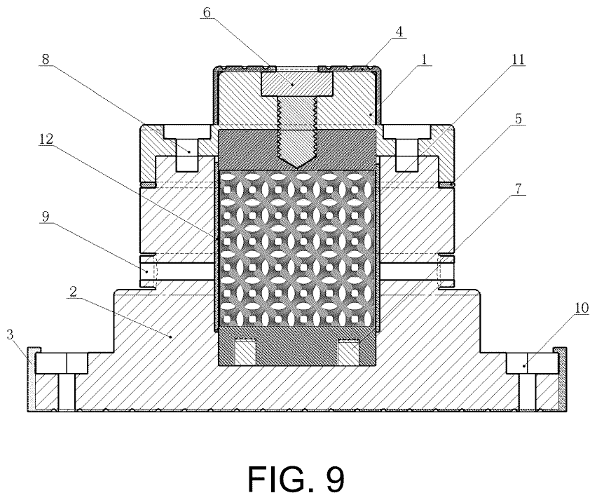

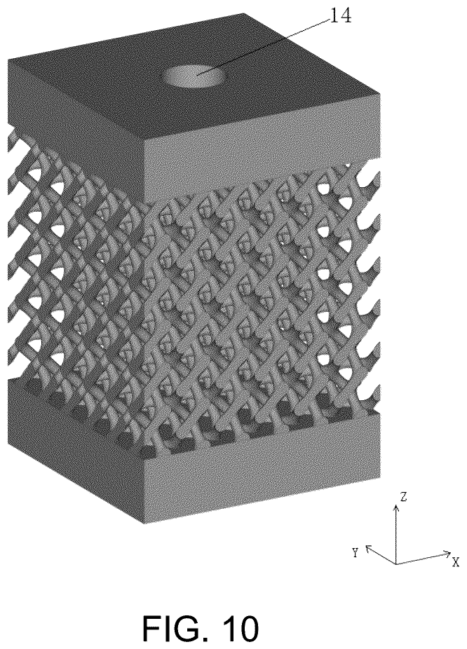

In another embodiment, a vibration isolator is further provided. The vibration isolator is a low-frequency vibration isolator and has the low-frequency vibration isolation component with the multicell interlacing triply periodic minimal surface lattice metamaterial designed by the design method of any of the aforementioned embodiments, as shown in FIGS. 7 to 9. The vibration isolator includes a connection cover 1, a base 2, and a vibration isolation component 11. Aa vibration isolation cavity 21 with an opening is disposed in the base 2. The vibration isolation component 11 is disposed in the vibration isolation cavity 21. The connection cover 1 is cooperatively connected to the base 2 to limit the vibration isolation component 11 in the vibration isolation cavity 21. Specifically, a bolt hole is opened in a middle of the connection cover 1, as shown in FIG. 10, and a round countersunk hole 14 corresponding to the bolt hole is opened on an upper base plate of the vibration isolation component 11. The fastening bolt 6 is disposed into the bolt hole and the corresponding round countersunk hole 14 to fix and connect the connection cover 1 and the vibration isolation component 11. At the same time, edge matching connection portions of the connection cover 1 and the base 2 are connected and fixed through the fixing bolt 8. Multiple bolt holes 10 are disposed on a lower periphery of the base 2 for connection to an external application device.

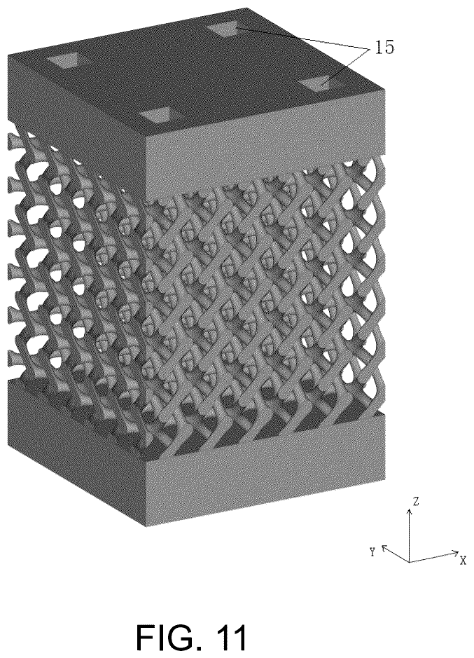

A bottom of the vibration isolation cavity 21 is provided with an implant frame 7. As shown in FIG. 11, four square countersunk holes 15 are opened on a bottom edge of the vibration isolation component 11. The implant frame 7 may be embedded in the square countersunk holes 15, so that the vibration isolation component 11 is fixedly connected to the vibration isolation cavity 21. An adjusting gasket 12 is disposed between the vibration isolation component 11 and a side wall of the vibration isolation cavity 21. Multiple adjusting screws 9 are symmetrically disposed on a side wall of the base 2. One end of the adjusting screw 9 is located in the vibration isolation cavity 21 and abuts against the adjusting gasket 12 to limit the vibration isolation component 11. The adjusting gasket 12 may protect a structure of the vibration isolation component 11 from being damaged due to the adjusting screw 9 of a handle. In addition, a sealing ring 5 is installed in a circumferential direction of a connection position between the connection cover 1 and the base 2 for sealing. A lower rubber vibration reduction friction pad 3 is sleeved on an outer side of one end of the base 2 away from the connection cover 1, and an upper rubber vibration damping friction pad 4 is sleeved on an outer surface of one end of the connection cover 1 away from the base 2.

More specifically, both upper and lower ends of the vibration isolation component 11 have a rectangular bottom plate with a thickness of 13 mm to 15 mm. The round countersunk hole 14 for fastening is disposed on the upper base plate. A lower bottom plate is provided with the four anti-shear square countersunk holes 15 with a depth of 13 mm to 15 mm, a length of 6 mm to 9 mm, and a width of 6 mm to 9 mm. The implant frame 7 may be embedded in each of the square countersunk holes.

The aforementioned lower rubber vibration reduction friction pad 3 is made of a thickened spike-type neoprene rubber, which is non-slip and durable, has high safety, reduces noise transmission, and has a long service life. It also has a circular concave-convex design to increase friction and ensure that the base is more non-slip and stable. The aforementioned upper rubber vibration reduction friction pad 4 is made of a NBR rubber, which has low gas permeability, good oil resistance, is impermeable to most general gases, and is suitable for bearing environments with high sealing requirements.

The aforementioned sealing ring 5 is made of a HNBR hydrogenated nitrile rubber with corrosion resistance and compression deformation resistance, and a Shore hardness thereof ranges from 70 to 95. For the sealing ring type, an O-type rubber sealing ring heavy-loading stepped combination is adopted, which is placed on an outer circumferential surface where the connection cover 1 is connected to the base 2 to prevent invasion of dust, hard inclusions, and corrosive media. The bolt countersunk holes in the vibration isolator for connecting the vibration isolation component 11 and the connection cover 1 are all sealed with rubber sleeves.

One end of the adjusting screw 9 away from an outer side of the vibration isolation component 11 is provided with a screw handle 13. The screw handle 13 may be rotated to fix the adjusting screw 9 along a circumferential direction of the vibration isolation component 11. A compression limit distance of a fixing nut on the adjusting screw 9 in a bearing direction of each of round holes is 0 mm to 3 mm.

The aforementioned adjusting gasket 12 adopts an elastic NR natural rubber sealing ring material with low compressibility modulus and large compression deformation, which is not easy to swell in the medium and has a small thermal shrinkage effect. It is used for buffering and connection during installation and fixation of the vibration isolation component 11, while filling a gap between connection surfaces, increasing a force-bearing surface of the vibration isolation component 11, effectively alleviating interface stress concentration, increasing strength and fatigue resistance of the connection surface, and preventing the connection interface from peeling off during use.

Next, in combination with actual application scenarios, technical solutions provided in the disclosure are introduced in detail through several embodiments.

### Embodiment 1

(1) A vibration absorber is installed between a ship shafting system and a hull according to the requirements to improve a mutual vibration transmission relationship between the shafting system and the hull. A frequency band required for vibration reduction is f=10-50 Hz. The effect of vibration isolation is 20 dB to 30 dB. A working load is 8 t. A rated working load is 10 t. A maximum working load is 12 t. Vertical stiffness is >900 MPa. Therefore, according to experimental experience and historical data, the gyroid double lattice structure is matched, and the material of Ni_{50.8}Ti_{49.2} is selected.

A Young's modulus of Ni_{50.8}Ti_{49.2} is 47 GPa. A Young's modulus of the double interlacing Gyroid structure with a volume fraction of 20% is experimentally measured to be 512.25 MPa. The Gibson-Ashby model may be obtained as follows:

$$\frac{{E}_{c}}{{E}_{s}} = {( {ρ}_{RD} )}^{2.8079} . \qquad ( 5 )$$

According to the actual required double interlacing Gyroid lattice structure, combined with the formulas (1) and (5), a double interlacing Gyroid lattice structure with a volume fraction of 25%, a Young's modulus of 958.46 MPa, and a cell size of 8 mm may be matched and obtained, and the material of Ni_{50.8}Ti_{49.2} may be selected for subsequent additive preparation.
(2) According to an implicit function formula of the above Gyroid lattice structure, the normal triply periodic minimal surface three-dimensional model is established to meet the structural characteristics and related force-vibration performance required by the vibration isolation component.
(3) According to the interlacing-cell number that is two, the modeling software is used to perform decomposition and interlacing, and a double interlacing triply periodic minimal surface three-dimensional model is established to meet the required structural characteristics and related force-vibration performance.
(4) The three-dimensional models of the double interlacing triply periodic minimal surface lattice structure and other parts are exported as STL files, and sliced and imported into the laser powder bed fusion device.
(5) The appropriate working parameters are selected, and the LPBF forming is performed under the protection of inert gas, so as to prepare the multicell interlacing triply periodic minimal surface lattice metamaterial vibration isolation component. The laser power is set to 125 w, the scanning speed to 600 mm/s, the layer thickness to 30 μm, the scanning interval to 100 μm, and the spot diameter to 50 μm. The forming is performed under the protection of inert gas of argon.
(6) After forming, the post processing is performed on the vibration isolation component. The in-situ annealing processing is performed under the protection of inert gas to remove the internal thermal stress of the sample. The sample is separated from the substrate using the wire cutting process, and the sand blasting processing is performed, so as to finally obtain the metamaterial vibration isolation component with the smooth surface and excellent performance.
(7) The vibration isolation component is assembled with other parts of the vibration isolator to obtain the vibration isolator having the double interlacing Gyroid triply periodic minimal surface lattice structure metamaterial vibration isolation component.

### Embodiment 2

(1) The vibration isolator is installed on a large transport vehicle, which may alleviate vibration impact of heavy loads on a vehicle transport bearing platform when the vehicle is transporting large goods. The frequency band for vibration reduction is required to be f=10-100 Hz, the effect of vibration isolation is required to reach 35 to 45 dB, the working load is required to be 15 t, the rated working load is required to be 18 t, the maximum working load is required to be 20 t, and the vertical stiffness is required to be >200 MPa. Therefore, according to the experimental experience and historical data, an octuple interlacing Gyroid lattice structure is matched, and the material of Ni_{50.8}Ti_{49.2} is selected.

The Young's modulus of Ni_{50.8}Ti_{49.2} is 47 GPa. A Young's modulus of the octuple interlacing Gyroid lattice structure with the volume fraction of 20% is experimentally measured to be 152.55 MPa, and the Gibson-Ashby model may be obtained as follows:

$$\frac{{E}_{c}}{{E}_{s}} = {( {ρ}_{RD} )}^{3.5605} . \qquad ( 6 )$$

According to the actual required octuple interlacing Gyroid lattice structure, combined with the formulas (1) and (6), an octuple interlacing Gyroid lattice structure with a volume fraction of 22%, a Young's modulus of 214.18 MPa, and the cell size of 8 mm may be matched and obtained, and the material of Ni_{50.8}Ti_{49.2} may be selected for the subsequent additive preparation.
(2) According to the implicit function formula of the Gyroid lattice structure, the normal triply periodic minimal surface three-dimensional model with a side length of 8 mm is established to meet the required structural characteristics and related force-vibration performance.
(3) According to the interlacing-cell number that is eight, the modeling software is used to perform the decomposition and interlacing, and an octuple interlacing triply periodic minimal surface three-dimensional model is established to meet the required structural characteristics and related force-vibration performance.
(4) The three-dimensional models of the octuple interlacing triply periodic minimal surface lattice structure and other parts are exported as STL files and sliced and imported into the laser powder bed fusion device.
(5) The appropriate working parameters are selected, and the LPBF forming is performed under the protection of inert gas to prepare the multicell interlacing triply periodic minimal surface lattice metamaterial vibration isolation component. The laser power is set to 125 w, the scanning speed to 600 mm/s, the layer thickness to 30 μm, the scanning interval to 100 μm, and the spot diameter to 50 μm. The forming is performed under the protection of inert gas of argon.
(6) After forming, the post processing is performed on the metamaterial vibration isolation component. The in-situ annealing processing is performed under the protection of inert gas to remove the internal thermal stress of the sample. The sample is separated from the substrate using the wire cutting process, and the sand blasting processing is performed, so as to finally obtain the metamaterial vibration isolation component with the smooth surface and excellent performance.
(7) The vibration isolation component is assembled with other parts of the vibration isolator to obtain the vibration isolator having an octuple interlacing Gyroid triply periodic minimal surface lattice structure metamaterial vibration isolation component.

### Embodiment 3

(1) The vibration absorber is installed on an aircraft engine group (a weight of a single unit is more than 4 tons), and an engine supporting base plate has its own channel steel bracket. The frequency band for vibration reduction is required to be f=100-200 Hz, the effect of vibration isolation is required to reach 30 to 40 dB, the working load is required to be 4 t, the rated working load is required to be 4.5 t, the maximum working load is required to be 6 t, and the vertical stiffness is required to be >400 MPa. Therefore, according to the experimental experience and historical data, a quadruple interlacing IWP lattice structure is matched and obtained, and the material of Ni_{50.8}Ti_{49.2} is selected.

The Young's modulus of Ni_{50.8}Ti_{49.2} is 47 GPa. A Young's modulus of the quadruple interlacing IWP lattice structure with the volume fraction of 20% is experimentally measured to be 259.13 MPa. The Gibson-Ashby model may be obtained as follows:

$$\frac{{E}_{c}}{{E}_{s}} = {( {ρ}_{RD} )}^{3.2313} . \qquad ( 7 )$$

According to the actual required quadruple interlacing IWP lattice structure, combining the formulas (1) and (7), a quadruple interlacing IWP lattice structure with a volume fraction of 24%, a Young's modulus of 467.06 MPa, and the cell size of 8 mm may be obtained, and the material of Ni_{50.8}Ti_{49.2} may be used for the subsequent additive preparation.
(2) According to an implicit function formula of an IWP porous structure, the normal triply periodic minimal surface three-dimensional model is established to meet the required structural characteristics and related mechanical vibration performance.
(3) According to the interlacing-cell number that is four, the modeling software is used to perform the decomposition and interlacing, and a quadruple interlacing triply periodic minimal surface three-dimensional model is established to meet the required structural characteristics and related force-vibration performance.
(4) The three-dimensional models of the quadruple interlacing IWP minimal surface lattice structure and other parts are exported as STL files, and sliced and imported into the laser powder bed fusion device.
(5) The appropriate working parameters are selected, and the LPBF forming is performed under the protection of inert gas to prepare the multicell interlacing triply periodic minimal surface lattice metamaterial vibration isolation component. The laser power is set to 125 w, the scanning speed to 600 mm/s, the layer thickness to 30 μm, the scanning interval to 100 μm, and the spot diameter to 50 μm. The forming is performed under the protection of inert gas of argon.
(6) After forming, the post processing is performed on the metamaterial vibration isolation component. The in-situ annealing processing is performed under the protection of inert gas to remove the internal thermal stress of the sample. The sample is separated from the substrate using the wire cutting process, and the sand blasting processing is performed, so as to finally obtain the metamaterial vibration isolation component with the smooth surface and excellent performance.
(7) The vibration isolation component is assembled with other parts of the vibration isolator to obtain the vibration isolator having a quadruple interlacing IWP triply periodic minimal surface lattice structure metamaterial vibration isolation component.

It should be understood that the above system is used to execute the method in the above embodiment. The corresponding program modules in the system have implementation principles and technical effects similar to those described in the above method. The working process of the system may be derived from the corresponding ones in the above method. The process will not be described again here.

Based on the methods in the above embodiments, embodiments of the present disclosure provide an electronic device. The device may include: at least one memory for storing a program and at least one processor for executing the program stored in the memory. When the program stored in the memory is executed, the processor is used to execute the method described in the above embodiments.

Based on the methods in the above embodiments, embodiments of the present disclosure provide a computer-readable storage medium. The computer-readable storage medium stores a computer program. When the computer program is run on a processor, the processor executes the method in the above embodiments.

Based on the methods in the above embodiments, embodiments of the present disclosure provide a computer program product. When the computer program product is run on a processor, the processor executes the method in the above embodiments.

It can be understood that the processor in the embodiments of the present disclosure may be a central processing unit (CPU), or other general-purpose processors, a digital signal processor (DSP), an application specific integrated circuit (ASIC), a field programmable gate array (FPGA) or other programmable logic devices, transistor logic devices, hardware components or any combination of the above. A general-purpose processor may be a microprocessor or any conventional processor.

The steps of the method in the embodiments of the present disclosure may be implemented by hardware or by a processor executing software instructions. Software instructions may be composed of corresponding software modules. The software modules may be stored in a random access memory (RAM), a flash memory, a read-only memory (ROM), a programmable rom (PROM), an erasable PROM (EPROM), an electrically EPROM (EEPROM), a register, a hard disk, a mobile hard disk, a CD-ROM or other forms of storage media known to persons skilled in the art. An exemplary storage medium is coupled to the processor such that the processor is able to read information from the storage medium and write information to the storage medium. Of course, the storage medium may also be an integral part of the processor. The processor and the storage media may be located in an ASIC.

The above embodiments may be implemented in whole or in part by software, hardware, firmware, or any combination thereof. When the above embodiments are implemented using software, they may be implemented in whole or in part in the form of a computer program product. The computer program product includes one or more computer instructions. When the computer program instructions are loaded and executed on a computer, all or part of the processes or functions described in the embodiments of the present disclosure are generated. The computer may be a general-purpose computer, a specific-purpose computer, a computer network, or other programmable device. The computer instructions may be stored in or transmitted over the computer-readable storage medium. The computer instructions may be transmitted from one website, computer, server or data center to another website, computer, server or data center in a wired manner (such as coaxial cable, optical fiber, digital subscriber line (DSL)) or a wireless manner (such as infrared, wireless, microwave, etc.). The computer-readable storage medium may be any available medium that can be accessed by a computer or a data storage device such as a server, data center, etc. that contains one or more available media integrated. The available media may be magnetic media (e.g., floppy disk, hard disk, magnetic tape), optical media (e.g., DVD), or semiconductor media (e.g., solid state disk (SSD)), etc.

It can be understood that the various numerical numbers involved in the embodiments of the present disclosure are only for convenience of description and are not used to limit the scope of the embodiments of the present disclosure.

Generally speaking, compared with the related art, the above technical solution conceived by the present disclosure has the following advantageous effects.

It is easy for those skilled in the art to understand that the above descriptions are only preferred embodiments of the present disclosure and are not intended to limit the present disclosure. Any modifications, equivalent substitutions and improvements, etc., made within the spirit and principles of the present disclosure should all be included in the protection scope of the present disclosure.

What is claimed is:

1. A design method of a low-frequency vibration isolation component with a multicell interlacing triply periodic minimal surface lattice metamaterial, comprising:
in step S1, determining a cell topology type and interlacing-cell number of the required triply periodic minimal surface lattice metamaterial, wherein the cell topology type comprises a Gyroid triply periodic minimal surface structure, an IWP triply periodic minimal surface structure, and a Diamond triply periodic minimal surface structure;
in step S2, constructing a corresponding normal triply periodic minimal surface three-dimensional model based on the cell topology type, and based on the interlacing-cell number, replicating the normal triply periodic minimal surface three-dimensional model with a corresponding interlacing-cell number along a preset direction at a preset spacing to obtain a multicell interlacing triply periodic minimal surface three-dimensional model, wherein the preset spacing is less than a side length of a corresponding cell structure;
in step S3, removing structures that are not interlacing at edges of the multicell interlacing triply periodic minimal surface three-dimensional model;
In step S4, constructing a bottom plate with a preset thickness on a pair of side surfaces of the multicell interlacing triply periodic minimal surface three-dimensional model with redundant structures removed to obtain a low-frequency vibration isolation component model.

2. The design method of the low-frequency vibration isolation component with the multicell interlacing triply periodic minimal surface lattice metamaterial according to claim 1, wherein a side length of the normal triply periodic minimal surface three-dimensional model is equal to a side length of the multicell interlacing triply periodic minimal surface three-dimensional model after removing the redundant structures.

3. The design method of the low-frequency vibration isolation component with the multicell interlacing triply periodic minimal surface lattice metamaterial according to claim 1, wherein in the step S1, when the cell topology type is determined to be a Gyroid surface, the corresponding interlacing-cell number is double interlacing, quadruple interlacing, or octuple interlacing; in the step S2, a normal Gyroid triply periodic minimal surface model is first constructed, and then based on the corresponding interlacing-cell number, the normal Gyroid triply periodic minimal surface model is replicated with the corresponding interlacing-cell number along the preset direction at the preset spacing to obtain a multicell interlacing Gyroid triply periodic minimal surface model.

4. The design method of the low-frequency vibration isolation component with the multicell interlacing triply periodic minimal surface lattice metamaterial according to claim 3, wherein in the step S2, performing multicell interlacing replication on the normal Gyroid triply periodic minimal surface model along the preset direction at the preset spacing multiple times to obtain the multicell interlacing triply periodic minimal surface three-dimensional model comprises following steps:
replicating the normal Gyroid triply periodic minimal surface model at a spacing of
$$\frac{a}{2}$$
in an X-axis direction to obtain a double interlacing Gyroid triply periodic minimal surface model, wherein a is a side length of a cell structure in the normal Gyroid triply periodic minimal surface model;
replicating the double interlacing Gyroid triply periodic minimal surface model at the spacing of
$$\frac{a}{2}$$
in a Y-axis direction to obtain a quadruple interlacing Gyroid triply periodic minimal surface model;
replicating the quadruple interlacing Gyroid triply periodic minimal surface model at
$$\frac{a}{4}$$
in the X-axis direction, the Y-axis direction, and a Z-axis direction respectively to an octuple interlacing Gyroid triply periodic minimal surface model.

5. The design method of the low-frequency vibration isolation component with the multicell interlacing triply periodic minimal surface lattice metamaterial according to claim 1, wherein in the step S1, when the cell topology type is determined to be an IWP surface, the corresponding interlacing-cell number is double interlacing or quadruple interlacing; in the step S2, a normal IWP triply periodic minimal surface model is constructed, and based on the corresponding interlacing-cell number, multicell interlacing replication is performed on the normal IWP triply periodic minimal surface model along the preset direction and at the preset spacing to obtain a multicell interlacing IWP triply periodic minimal surface model.

6. The design method of the low-frequency vibration isolation component with the multicell interlacing triply periodic minimal surface lattice metamaterial according to claim 5, wherein based on the corresponding interlacing-cell number, performing the multicell interlacing replication on the normal IWP triply periodic minimal surface model along the preset direction at the preset spacing comprises following steps:
replicating the normal interlacing IWP triply periodic minimal surface model at a spacing of
$$\frac{b}{2}$$
along an X-axis direction, and then replicating at
$$\frac{b}{4}$$
along a Y-axis direction to obtain a double interlacing IWP triply periodic minimal surface model, wherein b is a side length of a cell structure in the normal IWP triply periodic minimal surface model;
replicating the double interlacing IWP triply periodic minimal surface model at a spacing of
$$\frac{b}{8}$$
along an X-axis direction, and then replicating at
$$\frac{b}{2}$$
along the Y-axis direction to obtain a quadruple interlacing IWP triply periodic minimal surface model.

7. The design method of the low-frequency vibration isolation component with the multicell interlacing triply periodic minimal surface lattice metamaterial according to claim 1, wherein in the step S1, when the cell topology type is determined to be a Diamond surface, the corresponding interlacing-cell number is double interlacing or quadruple interlacing; in the step S2, a normal Diamond triply periodic minimal surface model is constructed, and based on the corresponding interlacing-cell number, multicell interlacing replication is performed on the normal Diamond triply periodic minimal surface model along the preset direction at the preset spacing to obtain a multicell interlacing Diamond triply periodic minimal surface model.

8. The design method of the low-frequency vibration isolation component with the multicell interlacing triply periodic minimal surface lattice metamaterial according to claim 7, wherein based on the corresponding interlacing-cell number, performing the multicell interlacing replication on the normal Diamond triply periodic minimal surface model along the preset direction at the preset spacing comprises following steps:
replicating the normal Diamond triply periodic minimal surface model at the spacing of
$$\frac{c}{4}$$
along an X-axis direction, and then replicating at
$$\frac{c}{8}$$
along a Y-axis direction to obtain a double interlacing Diamond triply periodic minimal surface model, wherein c is a side length of a cell structure in the normal Diamond triply periodic minimal surface model;
replicating the double interlacing Diamond triply periodic minimal surface model at the spacing of
$$\frac{c}{8}$$
along the X-axis direction, and then replicating at the spacing of
$$\frac{c}{4}$$
along the Y-axis direction to obtain a quadruple interlacing Diamond triply periodic minimal surface model.

9. A vibration isolator, comprising a connection cover, a base, and a vibration isolation component, a model of the vibration isolation component is obtained by the design method according to claim 1, a vibration isolation cavity with an opening is disposed in the base, the vibration isolation component is disposed in the vibration isolation cavity, and the connection cover is cooperatively connected to the base to close the opening of the vibration isolation cavity to limit the vibration isolation component in the vibration isolation cavity.

10. The vibration isolator according to claim 9, wherein an implant frame is disposed at a bottom of the vibration isolation cavity, a square countersunk hole is disposed on a bottom surface of the vibration isolation component, and the implant frame is embedded in the square countersunk hole; an adjusting gasket is disposed between the vibration isolation component and a side wall of the vibration isolation cavity; a plurality of pairs of adjusting screws are disposed on a side wall of the base, and one end of the adjusting screw is located in the vibration isolation cavity and abuts against the adjusting gasket to limit the vibration isolation component.
